(19) United States
(12) Patent Application Publication
(10) Pub. No.: US 2026/0116346 A1
(43) Pub. Date: Apr. 30, 2026

(54) ADAPTER ASSEMBLY FOR A VEHICLE WIPER SYSTEM

(71) Applicant: VALEO SYSTEMES D'ESSUYAGE, La Verriere (FR)

(72) Inventors: Thomas CAETANO, La Verriere (FR); Stephane HOUSSAT, La Verrière (FR); Vincent GAUCHER, La Verrière (FR)

(73) Assignee: VALEO SYSTEMES D'ESSUYAGE, La Verriere (FR)

(21) Appl. No.: 18/929,712

(22) Filed: Oct. 29, 2024

(51) Int. Cl. B60S 1/40

(52) U.S. Cl. CPC B60S 1/4048; B60S 2001/4051; B60S 2001/4054; B60S 2001/4093

(57) ABSTRACT

The present invention relates to an adapter assembly for a wiper system. The adapter assembly includes a spacer member releasably mounted on a base member. The spacer member includes side walls having stud that are received in corresponding orifices provided in longitudinal walls of the base member, to mount and secure the spacer member on the base member. The spacer member further includes a flexible leg provided on its upper wall for receiving and locking the yoke of the wiper arm with the spacer member. The flexible leg includes a vertically deformable cantilever portion having a locking tab adapted to allow the yoke to slide over the spacer member and lock the yoke with the spacer member. Thus, the spacer member makes the adapter assembly compatible with the wiper arm having a cut-out in the yoke, more specifically a cut-out in a top wall of the yoke.

### TECHNICAL FIELD

The present invention relates to a windscreen wiper system for a motor vehicle, and more particularly to an adapter assembly for connecting a windscreen wiper blade to an arm of a wiper system.

### BACKGROUND OF THE INVENTION

The wiper system traditionally consists of a wiper arm, one end of which is connected to an output shaft of a wiper motor through linkages and a wiper blade is attached to another end of the wiper arm. The wiper motor drives the wiper arm to swing between the predefined angular positions to wipe out the water and dirt present on the windshield.

Each wiper blade comprises a structure supporting a wiper rubber intended to be placed in contact with the windscreen so that it can remove water and/or dirt from the windscreen panel. Additionally, each wiper blade comprises a connector rigidly connected to the structure of the wiper blade, and an adapter assembly may be mounted pivotally on the connector in order to allow the detachable fastening of the wiper arm to the adapter assembly.

In a known manner, a yoke/clevis is formed at the end of the wiper arm and the yoke/clevis is engaged with the adapter assembly and locked therein. There are variety of wiper arms having different designs of the yoke, being used in different motor vehicles. This requires motor vehicle manufacturers to design adapter assembly specific to each type of wiper arm, an adapter assembly specifically making the link between a type of wiper arm and a connector. So, the equipment manufacturers needs to develop many different adapters, including at least one for each type of wiper arm on the market. Further, the users who need to change their wiper blade, needs to adapt and take extra care to choose the right adapter assembly for the type of wiper arm on which the wiper blade is to be mounted. This creates lot of inconvenience to the user while changing the wiper blades. Moreover, the part count of the adapter assembly may increase in order to make it compatible with different types of wiper arms. This may increase the material, weight, and/or cost associated with the adapter assembly.

The prior art and the conventional adapter assembly have various disadvantages as described above and there is a need for an adapter assembly for vehicle wiper system, that can overcome the disadvantages of the conventional wiper system.

### SUMMARY OF THE INVENTION

An object of the present invention is to solve the disadvantages described above of known adapter assembly. In particular, an object of the present invention is to provide an adapter assembly compatible with multiple wiper arms.

Another object of the present invention is to provide a spacer for an adapter assembly to make the adapter assembly compatible with a wiper arm having yoke with a cut-out in its top wall.

Yet another object of the present invention is to provide an adapter assembly with reduced part count, the adapter assembly being compatible with multiple wiper arms having different yoke designs.

In this context, the present invention is directed towards a spacer member of an adapter assembly for a wiper system. The spacer member may include a front end and a rear end longitudinally opposite to the front end. The spacer member may further include two side walls extending longitudinally between the front end and the rear end. The side walls may be spaced apart from each other and connected to each other by an upper wall. Preferably, the side walls may be substantially parallel to each other. The upper wall may be integrally formed with the side walls. A flexible leg may be provided extending longitudinally towards the rear end from a shoulder of the upper wall. The shoulder of the upper wall may be substantially positioned near front end of the spacer member. The flexible leg may include at least a cantilever portion being vertically offset from the upper wall. Preferably, the flexible leg may be integrally formed with the upper wall in such a way that the cantilever portion may be deformable along vertical axis i.e. the cantilever portion may be deformed towards the upper wall and/or away from the upper wall of the spacer member. A locking tab may be provided at a predefined location on the cantilever portion of the flexible leg, the locking tab extending towards the upper wall. A stud may be formed on an inner surface of at least one of the side walls. The stud may be adapted to be received in corresponding orifice provided in a base member of the adapter assembly. Preferably, the stud may be provided on each of the side walls of the spacer member. The studs provided on the side walls facilitates the mounting of the spacer member with a suitable base member to define the adapter assembly that can be attached to a wiper blade through a connector. Moreover, the flexible leg along with the locking tab facilitates attachment of a wiper arm to the adapter assembly. More specifically, the cantilever portion of the flexible leg allows a yoke of the wiper arm to slide over the spacer member, by deforming away from the upper wall. The locking tab may be provided at such a location on the cantilever portion that the locking tab may be received in a corresponding cut-out provided in the yoke, more specifically in a top wall of the yoke, to secure the wiper arm with the spacer member of the adapter assembly.

In a non-limiting embodiment of the present invention, the spacer member may further include a projection extending in longitudinally forward direction from the shoulder of the upper wall, the projection having a predefined curvature. The projection may be adapted to be received through a corresponding receiving space provided in the base member for securing the spacer member to the base member. The curvature of the projection may be adapted to cooperate with a bead formed in the base member to guide the spacer member while mounting it on the base member and to restrict vertical movement of the spacer member, more specifically the front end of the spacer member, with respect to the base member.

In a non-limiting embodiment of the present invention, the flexible leg may include a base portion fixed to the shoulder of the upper wall. The cantilever portion may extend longitudinally rearwards from the base portion. The base portion may have a predefined extension along the vertical axis i.e. height, such that the cantilever portion may be vertically offset from the upper wall thereby providing space for receiving the yoke of the wiper arm, more specifically the top wall of the yoke. The cantilever portion may be integrally formed with the base portion and may have a free end longitudinally opposite to the base portion, making the cantilever portion deformable along vertical axis.

In a non-limiting embodiment of the present invention, the locking tab may include an inclined surface facing in longitudinally rearward direction and a protrusion formed on longitudinally opposite side of the inclined surface. The inclined surface may be formed such that the longitudinal thickness of the locking tab at the cantilever portion is more than the longitudinal thickness at the free end of the locking tab. In other words, the inclined surface may be formed facing in longitudinally rearward direction such that the longitudinal thickness of the locking tab decreases from an end connected to the cantilever portion towards the other free end.

In a non-limiting embodiment of the present invention, each of the side walls may include a front portion formed near the front end of the spacer member, a rear portion formed near the rear end of the spacer member, and a middle portion connecting the front portion with the rear portion. The rear portion of the side wall may have less height i.e. vertical extension from the upper wall, compared to the height of the middle portion. In other words, the lower edge of the rear portion may be offset in vertically upward direction with respect to the lower edge of the middle portion. This offset may allow the proper mounting of the wiper arm on the spacer member by positioning pins provided on side walls of the yoke below the lower edge of the rear portion.

In a non-limiting embodiment of the present invention, the stud may be provided on the middle portion of at least one of the side walls. Preferably, the stud may be provided on the middle portions of both the side walls. The studs may have substantially cylindrical shape. However, the studs may have any other suitable shapes such as but not limited to rod having square cross-section, or rectangular cross-section, or triangular cross-section, or other polygonal cross-section. The studs may be provided on inner surfaces of the side walls and may extend towards central longitudinal axis of the spacer member. The studs may have same or different shapes and/or dimensions. The studs may be adapted such that they may be received in corresponding orifices provided in the base member to secure the spacer member to the base member. Moreover, the studs provided on middle portions of the two side walls may be aligned along the transverse axis.

In a non-limiting embodiment of the present invention, the stud may include a slant portion formed on lower portion of the stud, the slant portion facing in vertically downward direction. The slant portion may be formed such that the linear measurement of the stud along transverse axis, i.e. transverse extension from the inner surface of the side wall, may decrease in vertically downward direction at least in lower portion of the stud. The slant portion may facilitate deformation of the side walls while mounting the spacer member on the base member.

In a non-limiting embodiment of the present invention, the middle portion of the side wall may further include a supporting tab formed near a lower edge of the middle portion, the supporting tab extending transversely outwards from the middle portion. The supporting tab may guide and support the yoke, more specifically side walls of the yoke when the wiper arm is being attached to the spacer member.

In a non-limiting embodiment of the present invention, the flexible leg may include a lip formed at an end of the cantilever portion longitudinally opposite to the base portion. The lip may be formed by raising a portion of the free end of the cantilever portion in vertically upward direction. The lip may facilitate proper holding of the flexible leg, by the user, to deform the cantilever portion away from the upper wall of the spacer member, to unlock the locking tab while removing the wiper arm from the spacer member. However, it is to be understood that any other suitable holding structure/means may be provided on the flexible leg for deforming the flexible leg by the user.

The present invention also relates to an adapter assembly for a wiper system. The adapter assembly may include a base member and a spacer member. The base member may have a front end and a rear end longitudinally opposite to the front end. The spacer member may have two side walls spaced apart from each other and connected to each other by an upper wall. Preferably, the side walls of the spacer member may be substantially parallel to each other. The upper wall and the side walls of the spacer member may be integrally formed as a single unit. The spacer member may be releasably mounted on the base member to form the adapter assembly. The spacer member may include a flexible leg extending longitudinally rearwards from a shoulder of the upper wall of the spacer member. The shoulder of the upper wall of the spacer member may be substantially positioned near a front end of the spacer member. The flexible leg may include at least a cantilever portion being vertically offset from the upper wall of the spacer member. Preferably, the flexible leg may be integrally formed with the upper wall of the spacer member in such a way that the cantilever portion may be deformable along vertical axis i.e. the cantilever portion may be deformed towards the upper wall of the spacer member and/or away from the upper wall of the spacer member. The spacer member may further include a stud formed on an inner surface of at least one of the side walls. Preferably, the stud may be formed on both the side walls of the spacer member. The studs may be adapted to secure the spacer member to the base member. More specifically, the studs provided on the side walls of the spacer member facilitates the mounting of the spacer member with the base member to form the adapter assembly that can be attached to a wiper blade through a connector. Moreover, the flexible leg along with the locking tab facilitates attachment of a wiper arm to the spacer member of the adapter assembly. More specifically, the cantilever portion of the flexible leg of the spacer member allows a yoke of the wiper arm to slide over the spacer member, by deforming away from the upper wall of the spacer member. The locking tab may be provided at such a location on the cantilever portion of the flexible leg that the locking tab is received in a corresponding cut-out provided in the yoke, to secure the wiper arm with the spacer member and thereby with the adapter assembly.

In a non-limiting embodiment of the present invention, the stud may include a slant portion formed on lower portion of the stud, the slant portion facing in vertically downward direction. The slant portion may be formed such that the linear measurement of the stud along transverse axis, i.e. transverse extension from the inner surface of the side wall, may decrease in vertically downward direction at least in lower portion of the stud. The slant portion of the stud may facilitate deformation of the side walls of the spacer member while mounting the spacer member on the base member.

In a non-limiting embodiment of the present invention, the base member may include a pair of longitudinal walls extending along a longitudinal axis. The longitudinal walls may be spaced apart from each other and connected to each other by an upper wall. The longitudinal walls may be substantially parallel to each other and may be integrally formed with the upper wall of the base member.

In a non-limiting embodiment of the present invention, the base member may include a head formed at the front end of the base member. The head may be connected to the longitudinal walls and the upper wall of the base member. Preferably, the head, the longitudinal walls, and the upper wall of the base member may be integrally formed as a single unit.

In a non-limiting embodiment of the present invention, the base member may further include a receiving space continuously formed in the upper wall and the head of the base member.

In a non-limiting embodiment of the present invention, the spacer member may further include a projection extending in longitudinally forward direction from the shoulder of the upper wall of the spacer member. The projection may be received through the receiving space of the base member. The projection may have a predefined curvature to cooperate with a bead/beads formed in the head of the base member to guide the spacer member while mounting the spacer member on the base member and to restrict vertical movement of the spacer member, more specifically the front end of the spacer member, with respect to the base member.

In a non-limiting embodiment of the present invention, the base member may further include an orifice formed on at least one of the longitudinal walls to receive the stud provided on at least one of the side walls of the spacer member. Preferably, the orifice may be formed on each of the longitudinal walls of the base member to receive corresponding studs provided on the side walls of the spacer member. The orifices may have same or different shape and/or dimensions. The orifices may be adapted to receive corresponding studs of the spacer member to restrict vertically upward movement of the spacer member with respect to the base member. However, it is to be understood that the cooperation between the side walls of the spacer member having the studs and the longitudinal wall of the base members having corresponding orifices may also contribute to restricting translational movement along the longitudinal and transverse axes as well as rotational movement about the vertical and the longitudinal axes, of the spacer member with respect to the base member.

In a non-limiting embodiment of the present invention, the spacer member may further include a locking tab provided at a predefined location on the cantilever portion of the flexible leg, the locking tab extending towards the upper wall of the spacer member. The flexible leg along with the locking tab facilitates attachment of a wiper arm to the adapter assembly. More specifically, the cantilever portion of the flexible leg allows a yoke of the wiper arm to slide over the spacer member, by deforming away from the upper wall. The locking tab may be provided at such a location on the cantilever portion that the locking tab is received in a corresponding cut-out provided in the yoke, to secure the wiper arm with the spacer member of the adapter assembly.

In a non-limiting embodiment of the present invention, the locking tab of the spacer member may include an inclined surface facing in longitudinally rearward direction and a protrusion formed on longitudinally opposite side of the inclined surface. The inclined surface may be formed such that the locking tab has more longitudinal thickness at the cantilever portion than the longitudinal thickness at its free end. In other words, the inclined surface may be formed facing in longitudinally rearward direction such that the longitudinal thickness of the locking tab decreases from an end connected to the cantilever portion towards the other free end. The inclined surface of the locking tab may be adapted to cooperate with the yoke of the wiper arm to deform the cantilever portion of the flexible leg away from the upper wall of the spacer member, while sliding the yoke over the spacer member. Moreover, the protrusion of the locking tab may ensure locking of the yoke on the spacer member such that the locking tab of the spacer member may not easily come out of the cut-out of the yoke.

The present invention also relates to a wiper system for a motor vehicle. The wiper system may include a connector attached to a wiper blade, an adapter assembly pivotally connected to the connector, and a wiper arm releasably connected and secured to the adapter assembly. The wiper arm may include a yoke having a top wall connecting two side walls. The top wall of the yoke may include a cut-out. The adapter assembly may include a spacer member having two side walls spaced apart from each other and connected to each other by an upper wall. The spacer member may further include a flexible leg extending longitudinally rearwards from a shoulder of the upper wall. The spacer member may be releasably mounted on a base member. The flexible leg may include at least a cantilever portion being vertically offset from the upper wall of the spacer member. The flexible leg may further include a locking tab configured to cooperate with the cut-out of the yoke of the wiper arm. At least one of the side walls of the spacer member may include a stud adapted to be received in corresponding orifice provided in the base member, to secure the spacer member to the base member. Preferably, the spacer member may include studs provided on both the side walls and the studs may be received in corresponding orifices formed on longitudinal walls of the base member, to secure the spacer member to the base member.

In a non-limiting embodiment of the present invention, the spacer member may further include a projection extending in longitudinally forward direction from the shoulder of the upper wall of the spacer member. The projection of the spacer member may be received through a receiving space provided in the base member to secure at least a front end of the spacer member to the base member.

### BRIEF DESCRIPTION OF DRAWINGS

The present invention is expounded in detail below with the aid of the presented drawings. Items shown in the drawings are not to scale and are simplified to increase clarity of disclosure. In the drawings:

FIG. 1 illustrates a schematic perspective view of a wiper system, according to an embodiment of present invention;

FIG. 2 illustrates an exploded view of the wiper system, according to an embodiment of present invention;

FIG. 3 illustrates an exploded view of an adapter assembly, according to an embodiment of present invention;

FIG. 4A illustrates a schematic perspective view of a base member of the adapter assembly, according to an embodiment of present invention;

FIG. 4B illustrates a schematic perspective view from bottom side of the base member, according to an embodiment of present invention;

FIGS. 5A and 5B illustrate schematic perspective views of a spacer member of the adapter assembly, according to an embodiment of present invention;

FIG. 5C illustrates a schematic side view of the spacer member, according to an embodiment of present invention;

FIG. 5D illustrates a zoomed view of the zone ‘Z1’ of FIG. 5C, according to an embodiment of present invention;

FIG. 5E illustrates a schematic perspective view from back side of the spacer member, according to an embodiment of present invention;

FIG. 5F illustrates a schematic back view of the spacer member, according to an embodiment of present invention;

FIGS. 6A and 6B illustrate a schematic perspective view and front view, respectively, of a wiper arm, according to an embodiment of present invention;

FIGS. 7, 8, 9 and 10 illustrate assembly steps for connecting the wiper arm to the adapter attached to the wiper blade, according to an embodiment of present invention;

FIG. 7A illustrates a sectional view taken along line A-A in FIG. 7, according to an embodiment of present invention;

FIG. 8A illustrates a sectional view taken along line B-B in FIG. 8, according to an embodiment of present invention;

FIG. 8B illustrates a sectional view taken along line C-C in FIG. 8, according to an embodiment of present invention; and

FIG. 10A illustrates a sectional view taken along line D-D in FIG. 10, according to an embodiment of present invention.

### DETAILED DESCRIPTION OF THE INVENTION

The characteristics, variants and different modes of realization of the invention may be associated with each other in various combinations, in so far as they are not incompatible or exclusive with each other. In particular, variants of the invention comprising only a selection of features subsequently described in from the other features described may be imagined, if this selection of features is enough to confer a technical advantage and/or to differentiate the invention from prior art.

The following embodiments are examples. Although the description refers to one or more embodiments, this does not necessarily mean that each reference is to the same embodiment, or that the features apply only to one embodiment. Simple features of different embodiments may also be combined and/or interchanged to provide further embodiments.

In the present description, certain elements or parameters may be indexed, for example first element or second element as well as first parameter and second parameter or first criterion and second criterion, etc. In this case, it is a simple indexing operation to differentiate and name elements or parameters or criteria which are close, but not identical. In this case, simple indexing is used to differentiate and name elements or parameters or criteria which are close, but not identical. This indexing does not imply that one element, parameter or criterion has priority over another, and such names can easily be interchanged without going beyond the scope of this description. Nor does this indexing imply an order in time, for example to assess a particular criterion.

In the following detailed description, the terms ‘longitudinal’, ‘transverse’ and ‘vertical’ refer to the orientation of the wiper system according to the invention with reference to a trihedron L, V, T. Within this frame of reference, a longitudinal direction corresponds to a main direction of elongation of a wiper blade of this wiper system, this longitudinal direction being parallel to a longitudinal axis L of the trihedron L, V, T, illustrated in the figures. A vertical direction corresponds to a stacking direction of a connector, an adapter assembly and a wiper arm of the wiper system, this vertical direction being parallel to a vertical axis V of the trihedron L, V, T, and this vertical axis V being perpendicular to the longitudinal axis L. Finally, a transverse direction corresponds to a direction parallel to a transverse axis T of the trihedron L, V, T, this transverse axis T being perpendicular to the longitudinal axis L and the vertical axis V. The terminologies ‘longitudinally’, ‘transversely’, and ‘vertically’ may be understood with reference to the longitudinal axis L, transverse axis T, and the vertical axis V, respectively.

In addition, the designations ‘lower’ and ‘upper’ with respect to the elements of the wiper system are understood with respect to the distance of these elements from the wiper blade, a lower end/side of such elements corresponding to the end/side disposed in the vicinity of this wiper blade, while an upper end/side corresponds to the end/side disposed at a distance from the wiper blade. The designations ‘front’, ‘forward’, ‘rear’ and ‘rearward’ needs to be understood with reference to the longitudinal direction L. Further, the designation ‘height’ refers to the dimension of the component/element measured along the vertical axis L. Moreover the designations ‘inner’ and ‘outer’ are understood with respect to the longitudinal central axis of the component. For example, the surface disposed towards the longitudinal central axis of the component may be referred as “inner surface” and the surface disposed away from the longitudinal central axis of the component may be referred as “outer surface”. Moreover the terminologies ‘inwards’, and ‘outwards’ may be understood, accordingly.

The present invention relates to an adapter assembly for a wiper system used to clean a glazed surface of a vehicle, for example a windscreen, so as to improve driver's visibility of the road in front of the vehicle. The wiper system generally comprises at least one wiper arm carrying at one end, a wiper blade which extends mainly along the longitudinal axis L. The wiper blade comprises at least one wiper strip (rubber), intended to be in contact with the glazed surface to be cleaned, and a structure for supporting the said wiper strip. The wiper blade is secured to the wiper arm by an adapter assembly. The adapter assembly according to the present invention includes a spacer member to make the adapter assembly compatible with wiper arms of different types/designs. The adapter assembly further includes a base member adapted to be pivotally mounted on a connector that is fixed to the structure of the wiper blade. The spacer member is releasably mounted on the base member to make the adapter assembly compatible with a wiper arm having inverted U-shaped yoke with a cut-out provided in a top wall of the yoke. Particularly, the spacer member includes studs provided on its side walls. These studs are adapted to be received in corresponding orifices provided in longitudinal walls of the base member, to mount and secure the spacer member on the base member. A least one of the studs includes a slant portion which cooperated with the longitudinal walls of the base member to deform the side walls of the spacer member in transversely outward direction, while mounting the spacer member on the base member. The spacer member further includes a flexible leg provided on its upper wall for receiving and locking the yoke of the wiper arm with the spacer member. More particularly, the flexible leg includes a cantilever portion vertically offset from the upper wall of the spacer member, thereby providing a space to receive the top wall of the yoke. Further, a locking tab is provided on the cantilever portion of the flexible leg, the locking tab extending from the flexible leg towards the upper wall of the spacer member. The locking tab is provided with an inclined surface facing towards the yoke while sliding the yoke over the spacer member. The locking tab is adapted to deform the cantilever portion away from the upper wall of the spacer member to receive the top wall of the yoke in the space between the flexible leg and the upper wall of the spacer member. The locking tab is further adapted to be received in the cut-out of the yoke to lock the yoke of the wiper arm with the spacer member and thereby with the adapter assembly.

FIG. 1 illustrates a schematic perspective view of a wiper system 100, according to an embodiment of the present invention. The wiper system 100 may include at least one wiper arm 200, one end of which may be connected to an output shaft of a wiper motor (not shown) through suitable linkages. At least one wiper blade 500 may be connected to another end of the wiper arm 200. As shown, an adapter assembly 300 may be used as a connection means between the wiper arm 200 and the wiper blade 500. The adapter assembly 300, more particularly, allows the wiper blade 500 to be connected to a yoke 220 of the wiper arm 200. Further, the wiper blade 500 may include at least one wiper strip (rubber) intended to be in contact with the surface of the windshield to be cleaned.

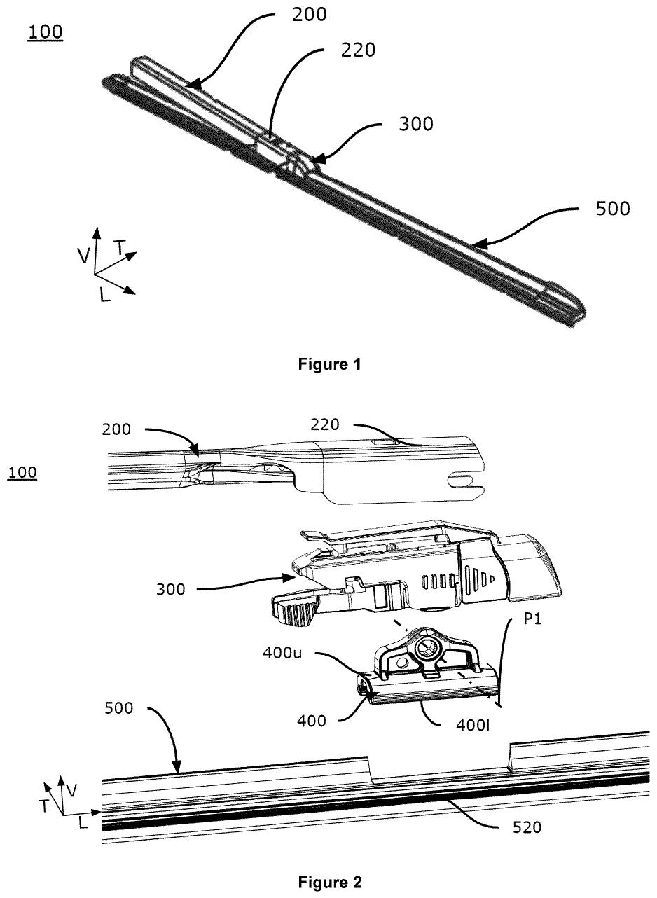

FIG. 2 illustrates an exploded view of the wiper system 100, more particularly, the connection between the wiper arm 200 and a connector 400 of the wiper blade 500 through the adapter assembly 300. The yoke 220 of the wiper arm 200 may be adapted to be releasably attached to the adapter assembly 300, from upper side of the adapter assembly 300. The connector 400 may be fixedly connected to a structure 520 of the wiper blade 500. The connector 400 may include an upper side 400u and a lower side 400l opposite to the upper side 400u, along the vertical axis V of the trihedron. In particular, the lower side 4001 of the connector 400 may be designed to carry the structure 520 of the wiper blade 500. The adapter assembly 300 may be located on the upper side 400u of the connector 400. The adapter assembly 300 may be pivotally connected to the connector 400 about a pivot axis P1, thereby allowing the wiper blade 500 to pivot at one of the ends of the wiper arm 200 to ensure that the wiper blade 500 is pressed against the glass surface to be wiped.

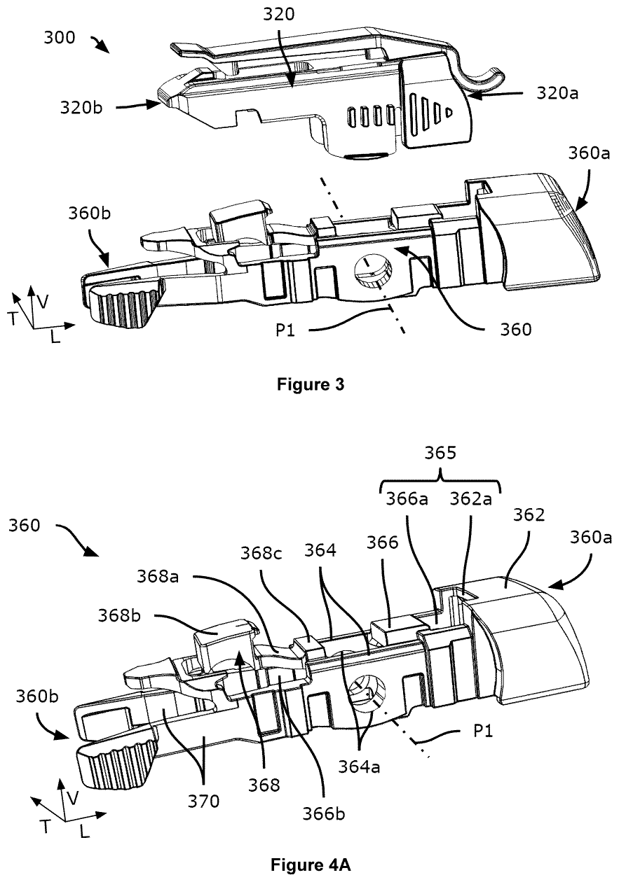

FIG. 3 illustrates an exploded view of the adapter assembly 300, according an embodiment of the present invention. The adapter assembly 300 may include a base member 360 and a spacer member 320 suitable for being mounted on each other along a vertical stacking direction, i.e., a direction parallel to the vertical axis V of the trihedron. The base member 360 may extend in a direction parallel to the longitudinal axis L of the trihedron, and may include a front end 360a and a rear end 360b arranged on either sides of the pivot axis P1. The base member 360 may be adapted to be pivotally mounted on the connector 400 (refer FIG. 2) about the pivot axis P1. The spacer member 320 may extend in a direction parallel to the longitudinal axis L of the trihedron, and may include a front end 320a and a rear end 320b longitudinally opposite to the front end 320a. The spacer member 320 may cooperate with the base member 360 from upper side of the base member 360 to define the adapter assembly 300. The base member 360 and the spacer member 320 may be arranged such that the front end 360a of the base member 360 and the front end 320a of the spacer member 320 are positioned on same side of the pivot axis P1, along the longitudinal axis L of the trihedron.

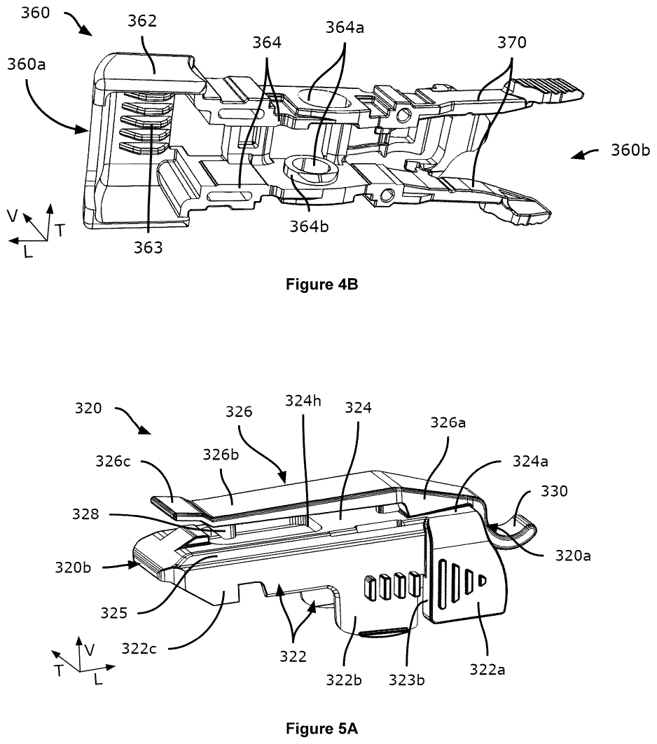

FIGS. 4A and 4B illustrate schematic perspective views of the base member 360 of the adapter assembly 300. The base member 360 may include a pair of longitudinal walls 364 extending along the longitudinal axis L of the trihedron. The longitudinal walls 364 may be substantially mutually parallel and spaced apart from each other transversely i.e. along the transverse axis T of the trihedron. The longitudinal walls 364 may be connected to each other by an upper wall 366 substantially perpendicular to the longitudinal walls 364. The longitudinal walls 364 along with the upper wall 366 may define the body of the base member 360. The longitudinal walls 364 and the upper wall 366 may define a space to accommodate the connector 400. The base member 360 may further include a head 362 formed at the front end 360a. Each of the longitudinal walls 364 may be connected to the head 362 and may extend longitudinally rearwards from the head 362. The head 362 may have the vertical and transverse dimensions greater than the body formed by the longitudinal walls 364 and the upper wall 366. In other words, the head 362 may extend beyond a longitudinal and transverse plane in which the upper wall 366 extends, and beyond a longitudinal and vertical plane in which the longitudinal walls 364 extend. When the spacer member 320 is mounted on the base member 360, the head 362 may cooperate with the front end 320a of the spacer member 320 to define an end-stop for the spacer member 320, thus preventing translational movement of the spacer member 320 in longitudinally forward direction.

The base member 360 may include two flexible tongues 370 extending rearwards from the longitudinal walls 364 along the longitudinal axis L of the trihedron. The flexible tongues 370 may be integrally formed with the longitudinal walls 364 of the base member 360. The flexible tongues 370 may be brought closer to each other by elastic deformation. The flexible tongues 370 may be substantially symmetrical about a plane of symmetry extending in longitudinal and vertical directions and situated equidistantly from the longitudinal walls.

The upper wall 366 may include a first opening 366a and a second opening 366b which are aligned in the longitudinal direction i.e. along the longitudinal axis L of the trihedron, and open onto the internal space formed between the longitudinal walls 364 and the upper wall 366. The first opening 366a may be formed in the vicinity of the head 362 and may continue to form a recess 362a in the head 362. The first opening 366a along with the recess 362a may define a receiving space 365 for insertion of a projection that may be provided on the front end 320a of the spacer member 320. The second opening 366b may be provided in the vicinity of the flexible tongues 370 and may be partially covered by a deformable member 368. The deformable member 368 may include a flexible stem 368a and a push-button 368b. The flexible stem 368a may extend mainly in the longitudinally rearward direction and may have a fixed end 368c some distance from the flexible tongues 370, which may be connected to the longitudinal walls 364 by a bridge of material. The push-button 368b may be formed at an end of the flexible stem 368a opposite to the fixed end 368c. The deformable member 368, especially the flexible stem 368a may elastically deform along the vertical axis V of the trihedron.

Each of the longitudinal walls 364 may include an orifice 364a. At least one of the orifices 364a may be substantially circular i.e. having circular cross-section. Both the orifices 364a may have same or different shapes and/or dimensions. The orifices 364a may together define the pivot axis P of the base member 360 relative to the connector 400. One of the orifices 364a may have a ring 364b projecting from the corresponding longitudinal wall 364 and extending towards the other longitudinal wall 364, as shown in FIG. 4B. The ring 364b may contribute to the assembling of the base member 360 with the connector 400 by this ring 364b being elastically clip-fastened to complementing means of the connector 400. The orifices 364a and the ring 364b may form a pivoting means for pivoting the base member 360 relative to the connector 400.

As shown in FIG. 4B, the base member 360 may further include a bead 363 provided under the head 362, that is to say the bead 363 may extend from the head 362 of the base member 360, in the direction of the wiper blade 500 when the adapter assembly 300 is mounted in the wiper system 100 for which it is intended. According to an exemplary embodiment, the head 362 may cooperate with the projection provided on the front end 320a of the spacer member 320. It is understood that the projection of the spacer member 320 may be inserted into the head 362 of the base member 360 through the receiving space 365 formed by the first opening 366a and the recess 362a, and then the projection may be slid under the aforementioned bead 363. The cooperation between the projection of the spacer member 320 and the bead 363 of the head 362 of the base member 360 may ensure the vertical locking of the spacer member 320 with respect to the base member 360, that is to say in the locking along the vertical axis V. According to an alternative variant, the projection of the spacer member may be engaged under the head 362 of the base member 360 which would be devoid of such a bead 363. According to another alternate variant, the base member 360 may be devoid of the receiving space 365 when the corresponding spacer member 320 is devoid of the projection.

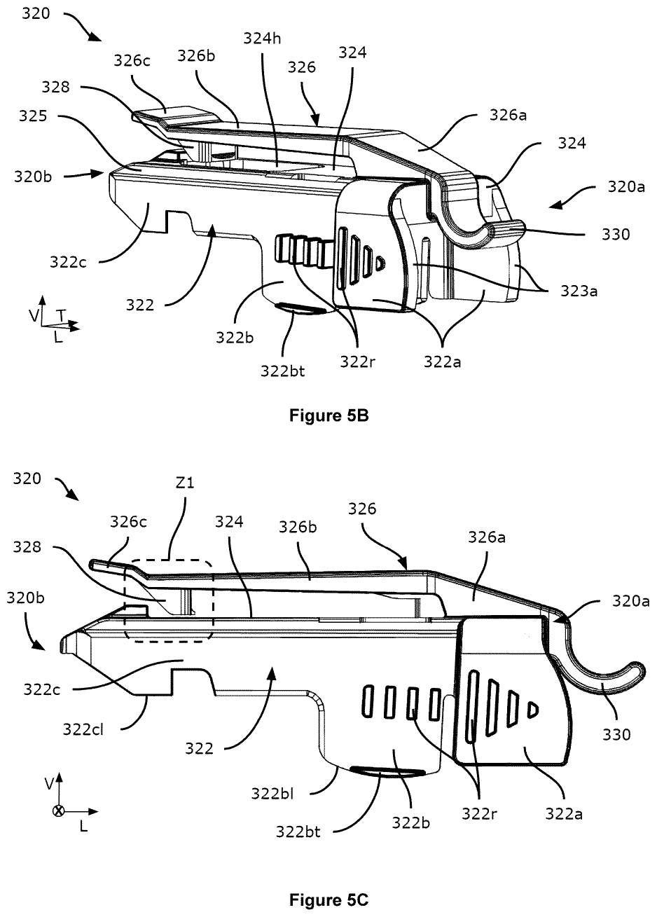

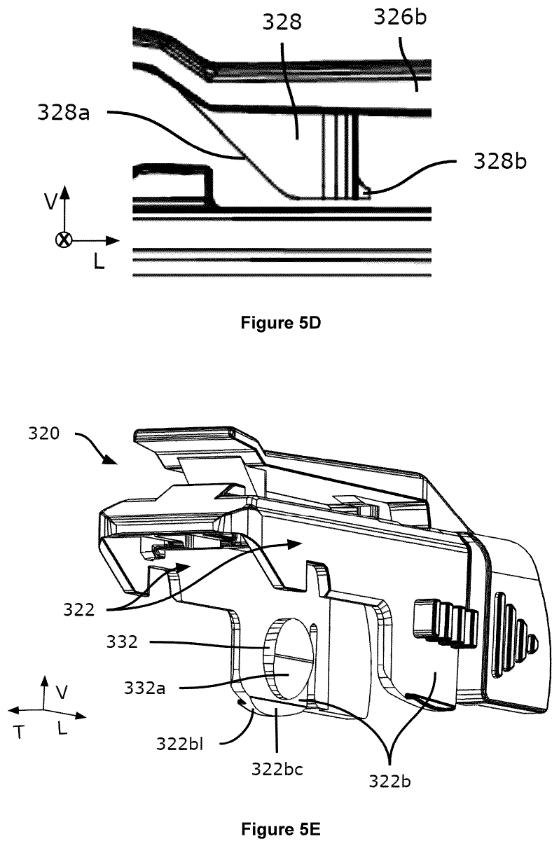

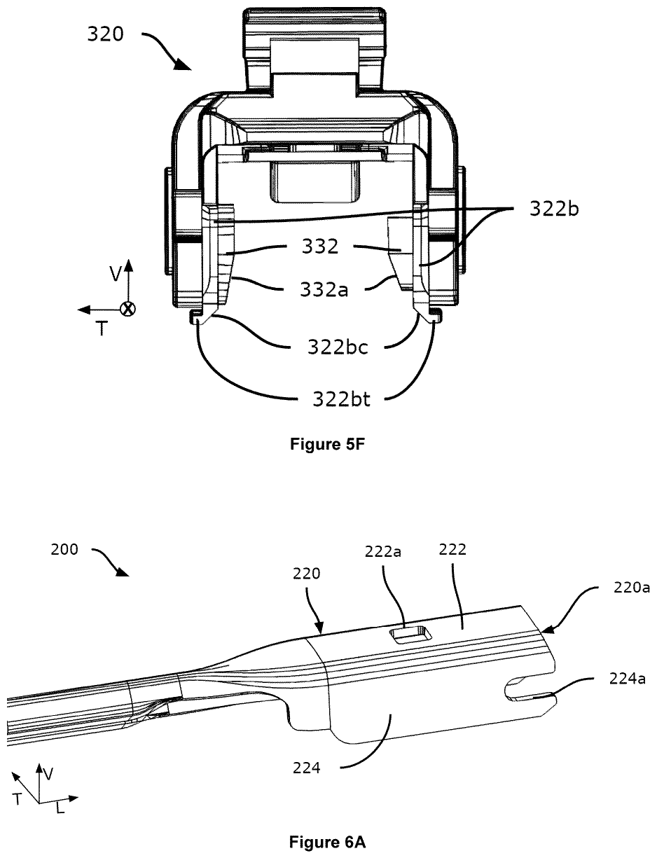

FIGS. 5A, 5B and 5C illustrate the spacer member 320 according to an exemplary embodiment of the present invention. The spacer member 320 may include two side walls 322 extending along the longitudinal axis L of the trihedron. The side walls 322 may be transversely spaced apart from each other by a predefined distance and may be connected to each other by an upper wall 324. More specifically, the upper wall 324 may connect the upper edges of the side walls 322. Preferably, a tapered portion 325 may be formed between the upper edges of the side wall 322 and the upper wall 324. Each side wall 322 may include a front portion 322a formed near front end 320a of the spacer member 320, a rear portion 322c formed near rear end 320b of the spacer member 320, and a middle portion 322b connecting the rear portion 322c to the front portion 322a. The front portion 322a of the side wall 322 may include a first abutting portion 323a formed at the front end 320a of the spacer member 320, by the thickness of the side walls 322 and the upper wall 324, as shown in FIG. 5B. The front portion 322a of the side wall 322 may have an outer surface being transversely offset from outer surface of the middle portion 322b of the side wall 322 such that a second abutting portion 323b may be formed in a plane parallel to the plane defined by the vertical axis V and the transverse axis T of the trihedron, as shown in FIG. 5A. Moreover, the middle portion 322b of the side wall 322 may have more height i.e. extension along the vertical axis V of the trihedron, than the height of the rear portion 322c. In other words, a lower edge 322bl of the middle portion 322b may be offset from a lower edge 322cl of the rear portion 322c, in vertically downward direction, as shown in FIG. 5C. The middle portion 322b of the side wall 322 may further include a supporting tab 322bt formed near the lower edge 322bl and extending transversely outwards from the outer surface of the middle portion 322b. The supporting tab 322bt may be adapted to cooperate with the yoke 220, more particularly, with at least a portion of a lower edge of a side wall of the yoke 220 of the wiper arm 200, to guide and support the yoke 220 while sliding the yoke 220 over the spacer member 320. Moreover, at least one rib 322r may be formed on at least one of the front portion 322a and the middle portion 322b of the side wall 322, as shown in FIGS. 5B and 5C. The rib 322r may extend in transversely outward direction from the outer surface of the side wall 322. Preferably, plurality of ribs 322r may be provided in a predefined pattern such that the ribs 322r provided on the middle portion 322b may be positioned in a slot provided in side walls of the yoke 220 of the wiper arm 200. The ribs 322r may have same or different dimensions. The ribs 322r provided on the middle portion 322b may be useful for the user to grip the spacer member 320 while mounting/releasing the spacer member 320 to/from the base member 360, and/or to grip the adapter assembly 300 while attaching/releasing the wiper arm 200 to/from the adapter assembly 300. The pattern of the ribs 322r provided on the middle portion 322b and/or the front portion 322a of the side walls 322, may additionally serve as an indication to guide the user for performing the assembly in a proper way. For example, as shown in FIGS. 5A, 5B and 5C, the pattern of the ribs 322r may create an arrow heading towards forward direction along the longitudinal axis L of the trihedrom, which may indicate to the user, the desired orientation of the spacer member 320 while mounting it on the base member 360. The arrow may also indicate the direction of sliding the yoke 220 over the spacer member 320 during attaching the wiper arm 200 to the adapter assembly 300. However, it is to be understood that the spacer member 320 may be devoid of the rib(s) 322r without affecting the intended functions of the spacer member 320.

The upper wall 324 may include a shoulder 324a formed near the front end 320a of the spacer member 320 and may connect the front portions 322a of the side walls 322, as shown in FIG. 5A. The upper wall 324 may further include a flank 324b extending from front end of the shoulder 324a, in vertically downward direction to a predefined distance, as shown in FIG. 5B. The flank 324b may be formed in a plane parallel to the plane defined by the vertical axis V and the transverse axis T of the trihedron. It is to be noted that the first abutting portions 323a of the side walls 322 along with the flank 324b of the upper wall 324 may define the front end 320a of the spacer member 320. The upper wall 324 may be continuously formed between the upper edges of the side walls 322, from front end 320a to the rear end 320b of the spacer member 320. Alternatively, a hole 324h may be formed at a predefined location on the upper wall 324. The hole 324h may have any desired shape such as but not limited to rectangular, square, or any other polygonal and/or circular shape. The hole 324h may be adapted to receive the push-button 368b of the deformable member 368 of the base member 360, when the spacer member 320 is assembled on the base member 360. It is to be understood that the upper wall 324 of the spacer member 320 may include additional holes or cavities that makes the spacer member 320 compatible with certain types of wiper arms.

The spacer member 320 may further include a flexible leg 326 provided on the upper wall 324, as shown in FIGS. 5A, 5B and 5C. Preferably, the flexible leg 326 includes a base portion 326a fixedly connected to the upper wall 324, more specifically, to the shoulder 324a of the upper wall 324. Preferably, the base portion 326a of the flexible leg 326 may be integrally formed with the upper wall 324. The flexible leg 326 may further include a cantilever portion 326b extending from the base portion 326a, rearwards along the longitudinal axis L of the trihedron. The cantilever portion 326b of the flexible leg 326 may be vertically offset from the upper wall 324 such that a gap may be formed between the cantilever portion 326b of the flexible leg 326 and the upper wall 324, as can be clearly seen in FIG. 5C. The cantilever portion 326b of the flexible leg 326 may be deformed along the vertical axis V of the trihedron i.e. the cantilever portion 326b may be biased away from the upper wall 324 of the spacer member 320. Preferably, the cantilever portion 326b may be integrally formed with the base portion 326a of the flexible leg 326. The flexible leg 326 may additionally include a lip 326c formed at rear end i.e. at an end of the cantilever portion 326b opposite to the base portion 326a. Preferably, the lip 326c may be formed integrally with the cantilever portion 326b of the flexible leg 326. As can be seen in FIG. 5C, the lip 326c may be formed by raising a portion near the free end of the cantilever portion 326b in vertically upward direction. It is to be understood that the spacer may include any alternate structure/means formed on the cantilever portion 326b which provides same function as the lip 326c i.e. providing means for holding/griping the cantilever portion 320b for the user to deform the flexible leg 326 while releasing the wiper arm from the spacer member 320.

The flexible leg 326 may further include a locking tab 328 provided at a predefined location on the flexible leg 326. Preferably, the locking tab 328 may extend from the cantilever portion 326b of the flexible leg 326, towards the upper wall 324 of the spacer member 320. As shown in FIG. 5D, the locking tab 328 may include an inclined surface 328a facing rearwards, along the longitudinal axis L of the trihedron. In other words, the inclined surface 328a may be formed on the locking tab 328 facing longitudinally rearwards such that the locking tab 328 has more thickness along the longitudinal axis L, near the cantilever portion 326b compared to the longitudinal thickness of the free end of the locking tab 328. Thus, the longitudinal thickness of the locking tab 328 may decrease from the cantilever portion 326b towards the free end. The inclined surface 328a may be adapted to cooperate with the yoke 220 of the wiper arm 200 to deform the flexible leg 326 away from the upper wall 324 of the spacer member 320, while sliding the yoke 220 over the spacer member 320. Further, the locking tab 328 may be adapted to be received in a cut-out provided in the yoke 220 when the yoke 220 is properly mounted on the spacer member 320. Moreover, a protrusion 328b may be formed at lower end of the locking tab 328 on longitudinally opposite side of the inclined surface 328a. The protrusion 328b may extend in forward direction along the longitudinal axis L.

The spacer member 320 may further include a projection 330 extending from the shoulder 324a of the upper wall 324, in longitudinally forward direction, as shown in FIGS. 5A, 5B and 5C. The projection 330 may emerge from the shoulder 324a of the upper wall 324 and/or the base portion 326a of the flexible leg 326. Preferably, the projection 330 may have a predefined curvature, as can be clearly seen sectional view in FIG. 5C. It is to be understood that the projection 330 may extend from the front end 320a of the spacer member 320. The projection 330 may be adapted to be received in the receiving space 365 of the base member 360 while mounting the spacer member 320 on the base member 360, and may cooperate with the bead 363 to vertically lock the spacer member 320, more specifically the front end 320a of the spacer member 320a, with respect to the base member 360. However, the spacer member 320 may be devoid of the projection 330 without affecting the functioning of the adapter assembly 300. Alternatively, the locking of the front end 320a of the spacer member 320 with the base member 360 may be achieved by any other suitable means.

FIGS. 5E and 5F illustrate perspective view from lower side and back view, respectively, of the spacer member 320. As shown, the spacer member 320 may include a stud 332 formed on inner surface of at least one of the side walls 322. Preferably, the stud 332 may be provided on both the side walls 322 of the spacer member 320. The stud 332 provided on the side walls 322 may have same or different shapes and/or dimensions. Preferably, the stud 332 may be formed on inner surface of the middle portion 322b of each side wall 322. The stud 332 may have a slant portion 332a formed towards lower side of the stud 332, the slant portion 332a facing in vertically downward direction, i.e. the linear measurement of the stud 332 along the transverse axis T may decrease in vertically downward direction, for at least a portion of the stud 332. Moreover, a chamfer 322bc may be formed at lower edge 322bl of the middle portion 322b of the side walls 322. The chamfer 322bc may be positioned vertically below the stud 332. The chamfer 322bc may be positioned transversely opposite to the supporting tab 322bt on the middle portion 322b of the side walls 322. The slat portion 332a of the studs 332 and the chamfer 322bc of the middle portion 322b of the side walls 322 may be adapted to facilitate deformation of the side walls 322 of the spacer member 320 transversely outwards while mounting the spacer member 320 over the base member 360. Preferably, the stud 332 may have a substantially cylindrical shape as shown in the FIGS. 5E and 5F. However, it is to be understood that the stud 332 may have any other shape such as rod having square cross-section, or rectangular cross-section, or triangular cross-section, or other polygonal cross-section etc.

It is to be understood that the spacer member 320 may include any additional features such as but not limited to cut-outs, protrusions, and/or inclined surfaces provided on suitable locations to ensure proper cooperation between the base member 360 and the spacer member 320 and/or between the spacer member 320 and the yoke 220 of the wiper arm 200. Also, the base member 360 may include additional features not disclosed herein which may make the base member 360 compatible with wiper arms having certain designs of the yoke or with different spacers.

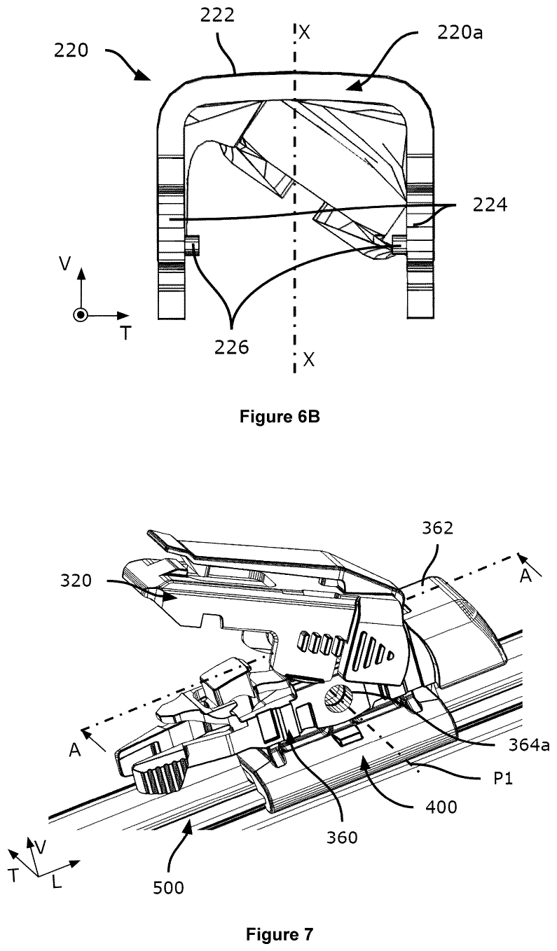

FIGS. 6A and 6B show the wiper arm 200, particularly, the end of the wiper arm 200 having the yoke 220 formed therein. The yoke 220 may generally be inverted U-shaped, with a top wall 222 connecting two side walls 224 extending along the longitudinal axis L. The side walls 224 and the top wall 222 may define a receiving zone suitable for receiving the adapter assembly 300. The yoke 220 may include a front end 220a which may be open so that the yoke 220 may be attached to the adapter assembly 300. The yoke 220 may further include a cut-out 222a formed at a predefined location on the top wall 222. Preferably, the cut-out 222a may be provided at such a location relative to the front end 220a that the locking tab 328 of the flexible leg 326 of the spacer member 320 may be received in the cut-out 222a to lock the yoke 220 with the spacer member 320 of the adapter assembly 300, when the yoke 220 is mounted on the adapter assembly 300. The cut-out 222a may have any predefined polygonal or curved or any other suitable shape. Each of the side walls 224 may include a slot 224a extending longitudinally rearwards from the front end 220a of the yoke 220, to a predefined distance. The slot 224a may be formed as an oblong cut-out open at the front end 220a of the yoke 220. The side walls 224 may include a pin 226 extending transversally towards central axis X-X of the yoke 220, from inner surface of each of the side walls 224, as shown in FIG. 6B. However, it is to be understood that the yoke 220 of the wiper arm 200 may be devoid of the slots 224a and/or the pins 226 without affecting the attachment of the yoke 220 with the spacer member 320 of the adapter assembly 300. Further, in case of the wiper arm 200 having no slot 224a on the side walls 224, the ribs 322r may not be formed on the middle portion 322b of the side walls 322 of the spacer member 320.

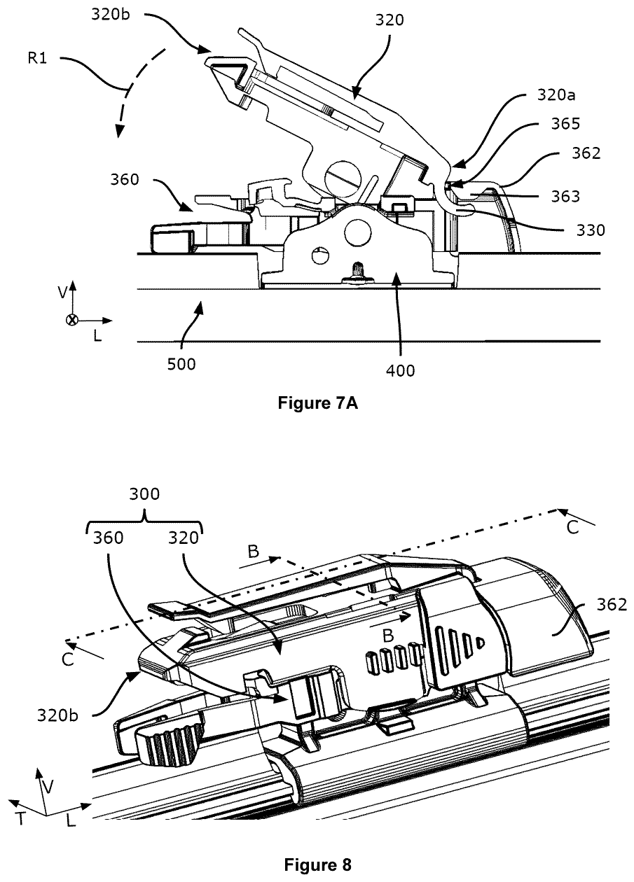

FIGS. 7, 8, 9 and 10 show steps of mounting the wiper arm 200 on the wiper blade 500. As shown in FIG. 7, the base member 360 may be pivotally mounted on the connector 400 of the wiper blade 500 about the pivot axis P1. The spacer member 320 may be tilted about the transverse axis T such that the front end 320a of the spacer member 320 is in the vicinity of the head 362 of the base member 360 and the rear end 320b of the spacer member 320 is vertically raised away from the base member 360. The projection 330 of the spacer member 320 may be received in through the receiving space 365 of the base member 360 such that the projection 330 may be positioned vertically below the bead 363 formed in the head 362 of the base member 360, as shown in sectional view in FIG. 7A. Once the projection 330 of the spacer member 320 is inserted in the head 362 through the receiving space 365 of the base member 360, the spacer member 320 may be rotated about the transverse axis T such that the rear end 320b of the spacer member 320 is moved towards the base member 360 as shown by arrow R1 in FIG. 7A.

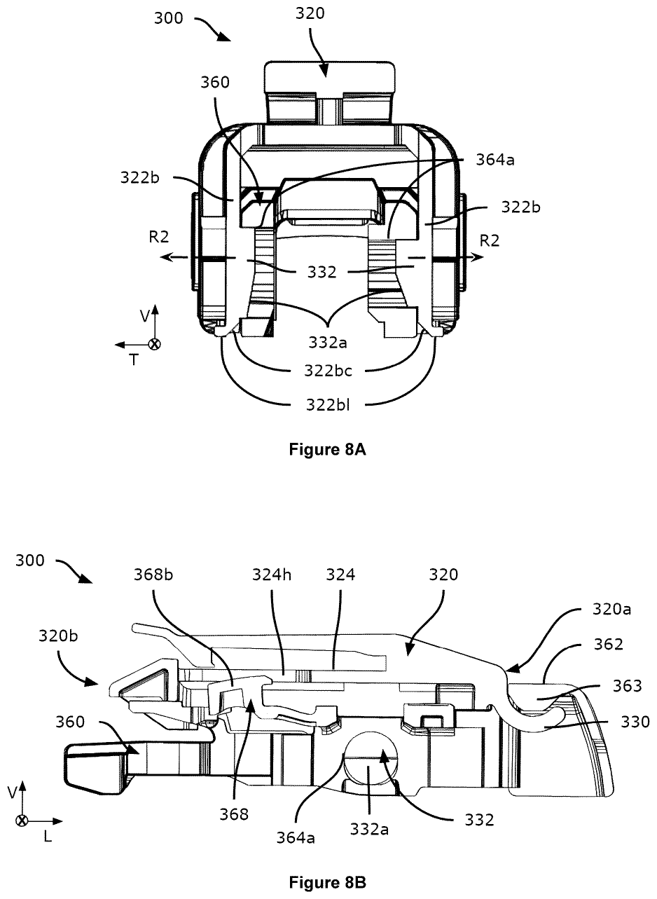

FIG. 8 shows the spacer member 320 mounted on the base member 360. With reference to the sectional view shown in FIG. 8A, when the rear end 320b of the spacer member 320 is moved towards the base member 360, the chamfer 322bc formed at the lower edge 322bl of the middle portion 322b of the side walls 322 may guide the side walls 322 of the spacer member over the longitudinal walls 364 of the base member 360. While rotating the spacer member 320, the slant portion 332a of the studs 332 may contact the body of the base member 360 to deform the side walls 322 transversely outwards as shown by arrows R2 in FIG. 8A. The spacer member 320 may be further rotated till the studs 332 of the spacer member 320 are received in the orifices 364a provided in the longitudinal walls 364 of the base member 360, and locked therein. It is to be noted that the shape and the dimensions of the stud 332 may be adapted according to the shape and dimension of the corresponding orifice 364a in which the stud 332 is intended to be received and locked. As shown in FIG. 8B, the push-button 368b of the deformable member 368 of the base member may be at least partially positioned in the hole 324h provided on the upper wall 324 of the spacer member 320. Alternatively, in case the upper wall 324 of the spacer member 320 is devoid of the hole 324h, the flexible stem 368a of the deformable member 368 may be biased vertically downwards such that the push-button 368b may be in contact with the upper wall 324 of the spacer member 320, and the deformable member 368 may stay deformed as long as the spacer member 320 is mounted on the base member 360. Further, in assembled state of the adapter assembly 300, as shown in FIG. 8B, the projection 330 of the spacer member 320 may be positioned below the bead 363 of the base member 360 to lock the spacer member 320, more specifically, the front end 320a of the spacer member 320 with respect to the base member 360. It is to be noted that the shape of the bead 363 may compliment with the curvature of the projection 330 to achieve desired cooperation between them. At this stage, the adapter assembly 300 is mounted on the connector 400 of the wiper blade 500. It is to be noted that the wiper arm 500 and the connector 400 are not shown in FIGS. 8A and 8B for ease of understanding.

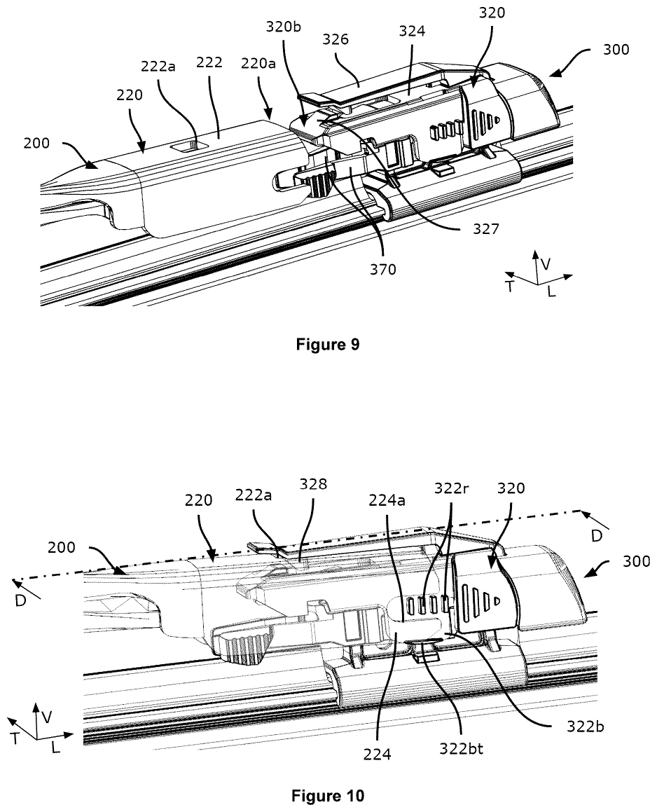

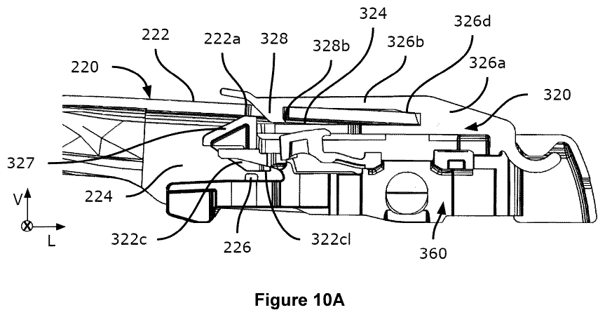

As shown in FIG. 9, the yoke 220 of the wiper arm 200 may be longitudinally aligned with the adapter assembly 300 such that the front end 220a of the yoke 220 is facing the rear end 320b of the spacer member 320 of the adapter assembly 300. The yoke 220 of the wiper arm 200 may be longitudinally moved forward along the longitudinal axis L of the trihedron, by deforming the flexible tongues 370 towards each other. The yoke 220 may be moved further in longitudinally forward direction such that the top wall 222 of the yoke 220 is received in the space between the flexible leg 326 and the upper wall 324 of the spacer member 320. During insertion of the yoke 220 over the spacer member 320, the front end of the top wall 222 touches the inclined surface 328a of the locking tab 328 formed on the flexible leg 326 and upon further longitudinal movement of the yoke 220, the front end of the top wall 222 slides over the inclined surface 328a to bias the cantilever portion 326b of the flexible leg 326 vertically upwards i.e. away from the upper wall 324. The yoke 220 may be further moved towards the front end 320a of the spacer member 320, in the space between the flexible leg 326 and the upper wall 324 till the yoke 220 reaches proper mounting position on the spacer member 320, as shown in FIG. 10. Additionally, a ramp 327 may be formed at the rear end 320b of the spacer member 320 to further facilitate the insertion of the yoke 220 in the space between the flexible leg 326 and the upper wall 324 of the spacer member 320. The ramp 327 may also allow locking of the yoke 220 with a desired angular inclination along the longitudinal axis L with respect to the spacer member 320. For example, the top wall 222 of the yoke 220 may not be parallel to the upper wall 324 of the spacer member 320. It can be seen in FIG. 10A that the portion of the top wall 222 of the yoke 220 which is in contact with the ramp 327 may be vertically raised compared to the front end 220a of the yoke. This may further ensure that the top wall 222 of the yoke 220 is biased against the flexible leg 326 to prevent detachment of the yoke 220 from the spacer member 320 of the adapter assembly 300. However, it is to be understood that the spacer member 320 may be devoid of the ramp 327 in which case the top wall 222 of the yoke 220 may cooperate with the upper wall 324 of the spacer member 320. Moreover, the flexible leg 326 may further include a bump 326d formed near the connection of the cantilever portion 326b and the base portion 326a, in the space between the upper wall 324 and the cantilever portion 326b. This bump 326d may cooperate with the front end 220a of the yoke, more specifically front end of the top wall 222 of the yoke 220, to limit the play of the yoke 220 with respect to the spacer member 320.

Upon complete insertion of the yoke 220 over the spacer member 320, the locking tab 328 may be received in the cut-out 222a of the yoke 220, as shown in FIGS. 10 and 10A. It is to be noted that in FIG. 10, the yoke 220 of the wiper arm 200 is made transparent to clearly show the cooperation between the yoke 220 and the spacer member 320. As shown, the locking tab 328 may be received in the cut-out 222a of the yoke 220 to lock the movement of the yoke 220 with respect to the spacer 320 of the adapter assembly 300 along the longitudinal axis L of the trihedron. The protrusion 328b (shown in FIG. 10A) formed on the locking tab 328 may ensure that the locking tab 328 may not easily come out of the cut-out 222a. Further, the flexible leg 326 may prevent vertically upward movement of the yoke 220 with respect to the spacer member 320, when the yoke 220 is secured to the spacer member 320 of the adapter assembly 300. Moreover, in case of the spacer member 320 having rib(s) 322r on the middle portion 322b of the side walls 322, the ribs 322r may be positioned in the slots 224a provided in the side walls 224 of the yoke 220. Preferably, the ribs 322r may extend transversely outward from the outer surface of the side wall 322 of the spacer member 320 such that the ribs 322r extend transversely beyond the outer surface of the side wall 224 of the yoke 220. These ribs 322r provided on the middle portion 322b of the side walls 322 may be used to properly grip the adapter assembly 300, more particularly, the spacer member 320 of the adapter assembly 300 while mounting and/or releasing the yoke 220 from the adapter assembly 300. Further, the lower edge of the side wall 224 of the yoke 220 may be supported by the supporting tab 322bt provided on the middle portion 322b of the side walls 322 of the spacer member 320, as shown in FIG. 10. As shown in longitudinal sectional view in the FIG. 10A, the pins 226 provided on inner surface of the side walls 224 of the yoke 200 may be positioned below the rear portion 322c of the side wall 322 of the spacer member 320 to further restrict vertically upward movement of the yoke 220 with respect to the adapter assembly 300. The rear portion 322c having less height from the upper wall 324 as compared to the height of the middle portion 322b, may ensure that the lower edge 322cl of the rear portion 322c is positioned vertically upwards with respect to the pins 226 of the yoke 220.

While releasing the yoke 220 of the wiper arm 200 from the adapter assembly 300, the cantilever portion 326b of the flexible leg 326 of the spacer member 320 may be deformed vertically upwards i.e. away from the upper wall 324 of the spacer member 320 to remove the locking tab 328 out of the cut-out 222a of the yoke 220. The user may hold the lip 326c provided on the cantilever portion 326b for unlocking the flexible leg 326 from the yoke 220. Then the abovementioned steps of mounting the wiper arm 200 to the adapter assembly 300 may be performed in reverse manner. So, once the yoke 220 is unlocked from the spacer member 320 of the adapter assembly 300, the yoke 220 may be moved rearwards along the longitudinal axis L to detach the yoke 220 from the adapter assembly 300. Additionally, to detach the spacer member 320 from the base member 360, the side walls 322 of the spacer member 320 may be deformed transversely outwards such that the studs 332 comes out of the orifices 364a. Further, the rear end 320b of the spacer member 320 may be raised upwards i.e. away from the base member 360 and the projection 330 of the spacer member 320 may be removed out of the receiving space 365 of the base member 360.

The invention shall not, however, be limited to the means and configurations described and illustrated herein, and shall also extend to any equivalent means or configuration described and illustrated herein, and to any technical combination operating such means.

LIST OF REFERENCE SIGNS

| | |
|---|---|
| 100 | Wiper system |
| 200 | Wiper arm |
| 220 | Yoke |
| 220a | Front end of the Yoke |
| 222 | Top wall of the Yoke |
| 222a | Cut-out |
| 224 | Side wall of Yoke |
| 224a | Slot |
| 226 | Pin |
| 300 | Adapter assembly |
| 320 | Spacer member |
| 320a | Front end of spacer member |
| 320b | Rear end of spacer member |
| 322 | Side wall |
| 322a | Front portion of side wall of |
| | the spacer member |
| 322b | Middle portion of side wall of |
| | the spacer member |
| 322bc | Chamfer |
| 322bl | Lower edge of the middle portion |
| | of side wall of the spacer member |
| 322bt | Supporting tab |
| 322c | Rear portion of side wall of the |
| | spacer member |
| 322cl | Lower edge of the rear portion of |
| | side wall of the spacer member |
| 322r | Rib |
| 323a | First abutting portion |
| 323b | Second abutting portion |
| 324 | Upper wall |
| 324a | Shoulder |
| 324b | Flank |
| 324h | Hole |
| 325 | Tapered portion |
| 326 | Flexible Leg |
| 326a | Base portion of the flexible leg |
| 326b | Cantilever portion of the flexible leg |
| 326c | Lip |
| 326d | Bump |
| 327 | Ramp |
| 328 | Locking tab |
| 328a | Inclined surface of the locking tab |
| 328b | Protrusion |
| 330 | Projection |
| 332 | Stud |
| 332a | Slant portion of the stud |
| 360 | Base member |
| 360a | Front end of base member |
| 360b | Rear end of base member |
| 362 | Head |
| 362a | Recess |
| 363 | Bead |
| 364 | Longitudinal wall |
| 364a | Orifice |
| 364b | Ring |
| 365 | Receiving space |
| 366 | Upper wall |
| 366a | First opening |
| 366b | Second opening |
| 368 | Deformable member |
| 368a | Flexible stem |
| 368b | Push-button |
| 368c | Fixed end of the flexible stem |
| 370 | Flexible tongue |
| 372 | Pivot member |
| 400 | Connector |
| 400u | Upper side of the connector |
| 400l | Lower side of the connector |
| 500 | Wiper blade |
| 520 | Structure |

1. A spacer member of an adapter assembly for a wiper system, the spacer member comprising:
a front end and a rear end longitudinally opposite to the front end;
two side walls extending longitudinally between the front end and the rear end, the side walls being spaced apart from each other and connected to each other by an upper wall;
a flexible leg extending longitudinally towards the rear end from a shoulder of the upper wall, the flexible leg including at least a cantilever portion being vertically offset from the upper wall;
a locking tab provided at a predefined location on the cantilever portion of the flexible leg, the locking tab extending towards the upper wall; and
a stud formed on an inner surface of at least one of the side walls, the stud being configured to be received in corresponding orifice provided in a base member of the adapter assembly.

2. The spacer member according to claim 1, further comprising a projection extending in longitudinally forward direction from the shoulder of the upper wall, the projection having a predefined curvature.

3. The spacer member according to claim 1, wherein the flexible leg includes a base portion fixed to the shoulder of the upper wall, and the cantilever portion extends longitudinally rearwards from the base portion.

4. The spacer member according to claim 3, wherein the flexible leg includes a lip formed at an end of the cantilever portion longitudinally opposite to the base portion.

5. The spacer member according to claim 1, wherein the locking tab includes an inclined surface facing in longitudinally rearward direction and a protrusion formed on longitudinally opposite side of the inclined surface.

6. The spacer member according to claim 1, wherein each of the side walls include a front portion formed near the front end of the spacer member, a rear portion formed near the rear end of the spacer member, and a middle portion connecting the front portion with the rear portion.

7. The spacer member according to claim 6, wherein the stud is provided on the middle portion of at least one of the side walls, the stud having substantially cylindrical shape.

8. The spacer member according to claim 7, wherein the stud includes a slant portion formed on lower portion of the stud, the slant portion facing in vertically downward direction.

9. The spacer member according to claim 6, wherein the middle portion further includes a supporting tab formed near a lower edge of the middle portion, the supporting tab extending transversely outwards from the middle portion.

10. An adapter assembly for a wiper system, the adapter assembly comprising:
a base member having a front end and a rear end longitudinally opposite to the front end; and
a spacer member having two side walls spaced apart from each other and connected to each other by an upper wall, the spacer member being releasably mounted on the base member,
wherein the spacer member includes a flexible leg extending longitudinally rearwards from a shoulder of the upper wall of the spacer member, the flexible leg including at least a cantilever portion being vertically offset from the upper wall of the spacer member, and
wherein the spacer member further includes a stud formed on an inner surface of at least one of the side walls, the stud being configured to secure the spacer member to the base member.

11. The adapter assembly according to claim 10, wherein the stud includes a slant portion formed on lower portion of the stud, the slant portion facing in vertically downward direction.

12. The adapter assembly according to claim 10, wherein the base member includes a pair of longitudinal walls extending along a longitudinal axis, the longitudinal walls being spaced apart from each other and connected to each other by an upper wall.

13. The adapter assembly according to claim 12, wherein the base member includes a head formed at the front end of the base member, the head being connected to the longitudinal walls and the upper wall of the base member.

14. The adapter assembly according to claim 13, wherein the base member further includes a receiving space continuously formed in the upper wall and the head of the base member.

15. The adapter assembly according to claim 14, wherein the spacer member further includes a projection extending in longitudinally forward direction from the shoulder of the upper wall of the spacer member, the projection being received through the receiving space of the base member.

16. The adapter assembly according to claim 12, wherein the base member further includes an orifice formed on at least one of the longitudinal walls to receive the stud provided on at least one of the side walls of the spacer member.

17. The adapter assembly according to claim 10, wherein the spacer member further includes a locking tab provided at a predefined location on the cantilever portion of the flexible leg, the locking tab extending towards the upper wall of the spacer member.

18. The adapter assembly according to claim 17, wherein the locking tab includes an inclined surface facing in longitudinally rearward direction and a protrusion formed on longitudinally opposite side of the inclined surface.

19. A wiper system for a motor vehicle, the wiper system comprising:
a connector attached to a wiper blade;
an adapter assembly pivotally connected to the connector; and
a wiper arm releasably connected and secured to the adapter assembly,
wherein the wiper arm includes a yoke having a top wall connecting two side walls, the top wall of the yoke including a cut-out,
wherein the adapter assembly includes a spacer member having two side walls spaced apart from each other and connected to each other by an upper wall, and a flexible leg extending longitudinally rearwards from a shoulder of the upper wall,
wherein the spacer member is releasably mounted on a base member,
wherein the flexible leg includes at least a cantilever portion being vertically offset from the upper wall of the spacer member,
wherein the flexible leg further includes a locking tab configured to cooperate with the cut-out of the yoke of the wiper arm, and
wherein at least one of the side walls of the spacer member includes a stud configured to be received in corresponding orifice provided in the base member, to secure the spacer member to the base member.

20. The wiper system according to claim 19, wherein the spacer member further includes a projection extending in longitudinally forward direction from the shoulder of the upper wall of the spacer member, the projection being received through a receiving space provided in the base member.
